(19) United States
(12) Patent Application Publication
(10) Pub. No.: US 2015/0206259 A1
(43) Pub. Date: Jul. 23, 2015

(54) DISH REMAINING AMOUNT DETECTION APPARATUS AND DISH REMAINING AMOUNT DETECTION METHOD

(71) Applicant: TOSHIBA TEC KABUSHIKI KAISHA, Tokyo (JP)

(72) Inventor: Nobuyuki Takahashi, Kannami Tagata Shizuoka (JP)

(21) Appl. No.: 14/592,036

(22) Filed: Jan. 8, 2015

(30) Foreign Application Priority Data
Jan. 23, 2014 (JP) 2014-010503

(51) Int. Cl. G06Q 50/16; G06K 9/00

(52) U.S. Cl. CPC G06Q 50/16; G06K 9/00771

(57) ABSTRACT

In accordance with one embodiment, a dish remaining amount detection apparatus comprises an input module configured to input an image of a container used in dining for placing dish and an image of the dish placed on the container captured by a camera; a remaining amount detection module configured to detect the remaining amount of the dish remaining in the container from the image input by the input module; an end determination module configured to determine whether or not the eating of the dish is ended according to the remaining amount of the dish detected by the remaining amount detection module; and an information output module configured to output information indicating that the eating of a dish is ended if the end determination module determines that the eating of the dish is ended.

### CROSS-REFERENCE TO RELATED APPLICATION

This application is based upon and claims the benefit of priority from Japanese Patent Application No. 2014-010503, filed Jan. 23, 2014, the entire contents of which are incorporated herein by reference.

### FIELD

Embodiments described herein relate generally to a dish remaining amount detection apparatus and a dish remaining amount detection method.

### BACKGROUND

In a case in which a customer P ordered a course meal or a plurality of dishes in a food and drink shop such as a restaurant, the timing for a catering clerk to serve the next dish or the timing for a cook to cook the next dish is determined by experience according to the time elapsed since the former dish is served. Alternatively, the timing is determined by the catering clerk and the like who patrols between the customer seats to confirm the dining progress of the customer P.

However, the dining speed of the customer P varies according to different persons, thus, it is improper to determine the ending of the dining uniformly according to the time elapsed since the former dish is served. Further, even though the catering clerk and the like sees the dining progress, it is difficult to determine whether the dining is still continued or ended already. As a result, the catering clerk and the like cannot determine the ending of each dish correctly, and the next dish cannot be served at a proper timing.

### BRIEF DESCRIPTION OF THE DRAWINGS

FIG. 1 is a system diagram illustrating the connection relation between each device of a dish management system according to one embodiment;

FIG. 2 is a perspective view illustrating the arrangement around a table in a restaurant;

FIG. 3 is a conceptual diagram illustrating an example of an image captured by a camera shown in FIG. 2 from above;

FIG. 4 is a conceptual diagram illustrating another example of the image captured by the camera shown in FIG. 2 from above;

FIG. 5 is a block diagram illustrating the hardware constitution of a dish remaining amount detection apparatus;

FIG. 6 is a table map of a dining progress table;

FIG. 7 is a functional block diagram illustrating the functional components of the dish remaining amount detection apparatus;

FIG. 8 is a flowchart illustrating a control processing of the dish remaining amount detection apparatus;

FIG. 9 is a flowchart illustrating a control processing of the dish remaining amount detection apparatus;

FIG. 10 is a diagram illustrating a state in which a knife and a fork are placed in a container in a manner of being parallel to each other;

FIG. 11 is a diagram illustrating state in which the knife and the fork are placed in the container in a manner of being nonparallel to each other;

FIG. 12 is a diagram illustrating an example of the image of the container and the dish;

FIG. 13 is a diagram illustrating another example of the image of the container and the dish;

FIG. 14 is a diagram illustrating another example of the image of the container and the dish; and

FIG. 15 is a diagram illustrating a monitor for displaying an example of dining progress state.

### DETAILED DESCRIPTION

In accordance with one embodiment, a dish remaining amount detection apparatus comprises an input module configured to input an image of a dining tool used during dining captured by a camera; an end determination module configured to determine whether or not the dining is ended according to the image of the dining tool input by the input module; and an information output module configured to output information indicating that the eating of a dish is ended if the end determination module determines that the eating of the dish is ended.

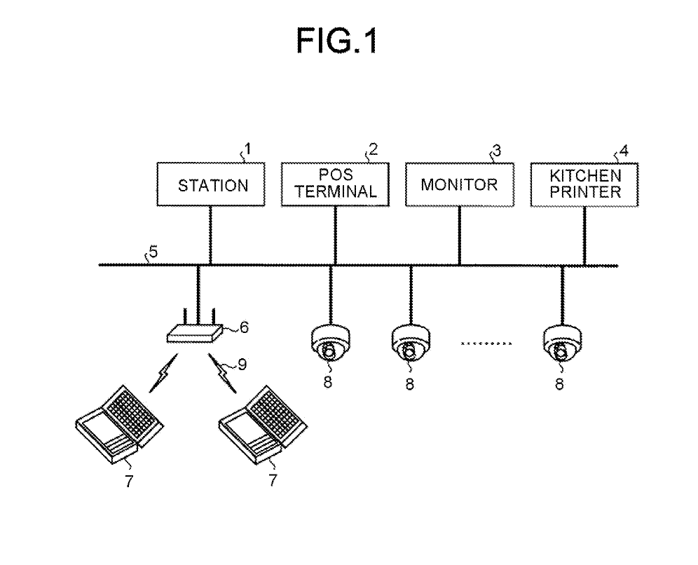

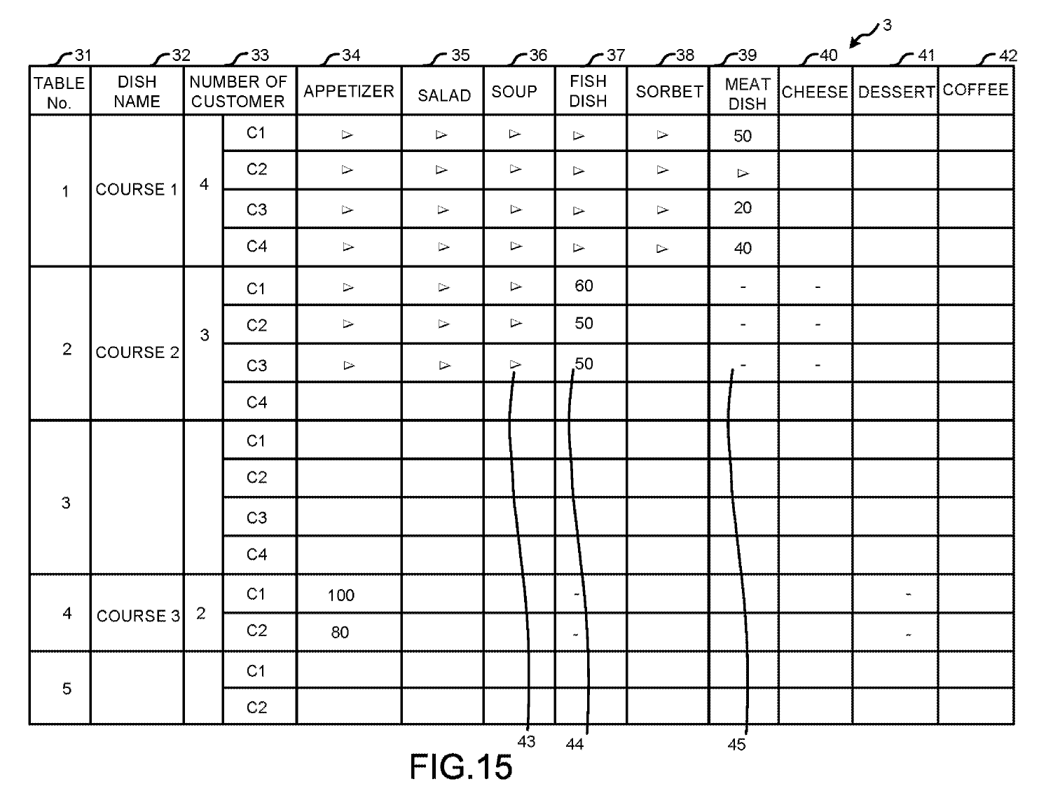

Hereinafter, the dish remaining amount detection apparatus and the dish remaining amount detection method according to the embodiment are described in detail with reference to FIG. 1˜FIG. 15. In the following embodiment, a station is described as an example of the dish remaining amount detection apparatus; however, the present invention is not limited to this.

FIG. 1 is a system diagram illustrating the connection relation between each device of a dish management system according to the embodiment. In FIG. 1, the dish management system includes a station 1, a POS (Point of Sales) terminal 2, a plurality of monitors 3, a kitchen printer 4, a wireless base station 6 and a plurality of cameras 8, which are connected with each other through a LAN (Local Area Network) 5. The dish management system further includes a handy terminal 7 which is connected with the wireless base station 6 through a wireless LAN 9.

The station 1, serving as a central device of the dish management system, manages orders received from the handy terminal 7 through the wireless base station 6. The station 1 also sends order information to the kitchen printer 4 arranged in the kitchen. The station 1 manages dining progress based on the video from the camera 8 and meanwhile displays the dining progress on the monitor 3. The station 1 sends the settlement information based on the order information to the POS terminal 2.

The POS terminal 2 executes settlement processing of the food fee for the food ordered by a customer P in a restaurant. The monitor 3, arranged at a kitchen where food is cooked and a place where attendants wait, displays dishes to be served to the customer P and the dining progress of the customer P. The kitchen printer 4 prints the dishes relating to the order of dishes received from the handy terminal 7 to notify the cook.

The wireless base station 6, equipped with an antenna for transmitting and receiving radio, establishes an electrical connection with the handy terminal 7 through the wireless LAN 9, and transmits and receives information interactively with the handy terminal 7 through the wireless LAN 9. The wireless base station 6 sends the order received from the handy terminal 7 to the station 1 through the LAN 5.

The handy terminal 7 inputs the order of the dishes that the customer P desires. The handy terminal 7 sends the input order to the wireless base station 6 through the wireless LAN 9.

The camera 8 is arranged at the ceiling above each table where the customer P dines in a manner of being directed downward to photograph the whole table beneath. The camera 8 captures an image of the whole table every a pre-determined time (for example, 30 seconds). The camera 8 sends the image to the station 1 through the LAN 5 every time an image is captured.

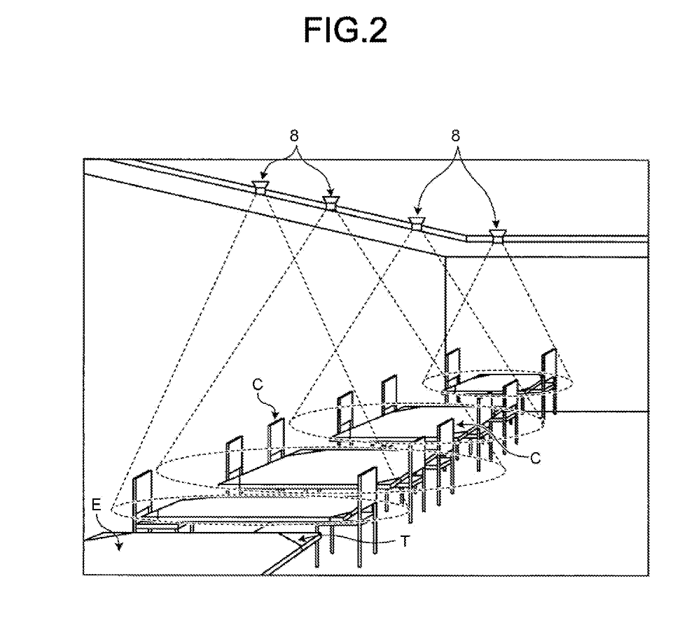

FIG. 2 is a perspective view illustrating the arrangement relation between the camera 8 and the table in a restaurant. It is shown in FIG. 2 that a plurality of tables T is arranged side by side in the store. Each table T is covered with a tablecloth E. It is preferred that the color of the table T and the color of the tablecloth E are in contrast to the color of containers D placed on the table T or the tablecloth E. A plurality of chairs C is arranged around each table T. In the example shown in FIG. 2, two or four chairs C are arranged around one table T.

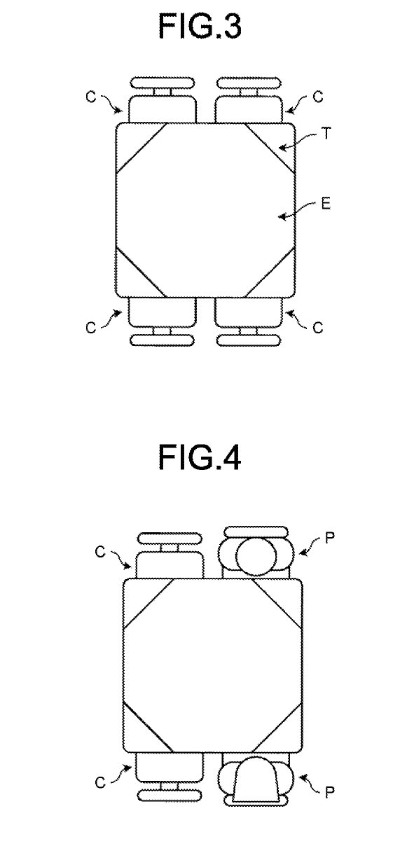

The camera 8 is arranged at the ceiling above each table T. One camera 8 can photograph the chairs C, the tablecloth E and the table T arranged beneath. FIG. 3 is a diagram illustrating an image captured by the camera 8. In FIG. 3, the camera 8 photographs the table T, the tablecloth E and four chairs C. The, camera 8 in FIG. 3 photographs a state in which no customer P is seated in one of the four chairs C.

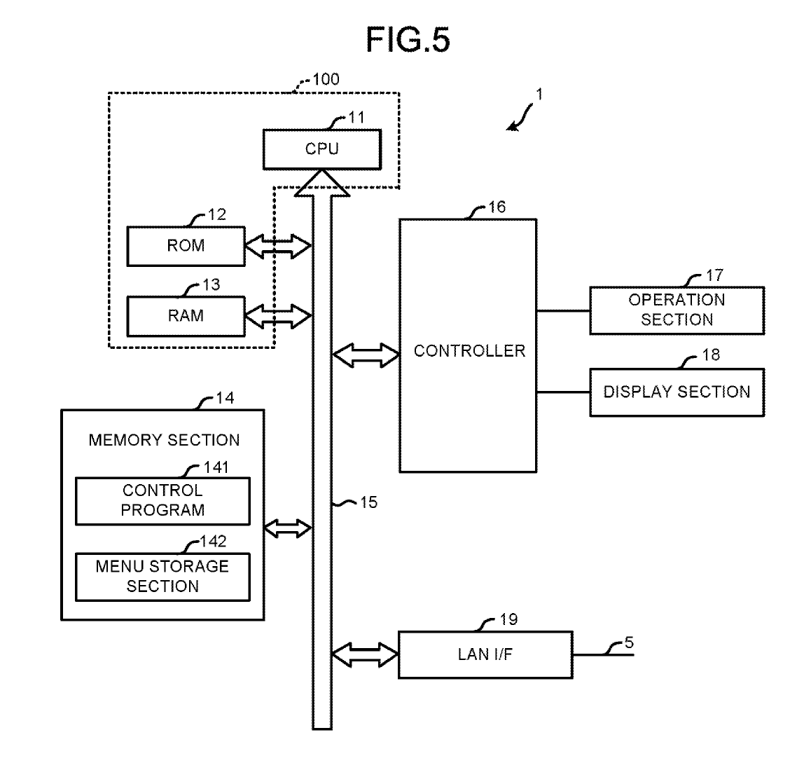

FIG. 4 is a diagram illustrating an image captured by the camera 8. In FIG. 4, the camera 8 photographs the table T, the tablecloth E and four chairs C. The camera 8 photographs a state in which two customers P are seated in two of the four chairs C. In FIG. 4, the two chairs C where the customers P are seated are almost not photographed by the camera 8; instead, the heads of the customers P are photographed.

FIG. 5 is a block diagram illustrating the hardware constitution of the station 1. In FIG. 5, the station 1 includes a CPU (Central Processing Unit) 11 serving as a control main body, a ROM (Read Only Memory) 12 for storing various programs, a RAM (Random Access Memory) 13 for copying or decompressing various data thereon, and a memory section 14 for storing various programs, which are connected with each other through a data bus 15. The CPU 11, the ROM 12 and the RAM 13 constitute a control section 100. That is, the control section 100 executes the later-described control processing by the CPU 11 which operates according to a control program 141 that is stored in the ROM 12 or the memory section 14 and is copied or decompressed on the RAM 13.

The RAM 13 further stores the image captured by the camera 8, in addition to copying or decompressing various programs including the control program 141 thereon. The RAM 13 stores a later-described dining progress table 131.

The memory section 14, which is a nonvolatile memory such as a flash memory or a HDD (Hard Disc Drive) which keeps the stored information even if the power source is cut off, stores programs including the control program 141 and the like. The memory section 14 includes a menu storage section 142 in which the information of menu of the dishes sold in the restaurant is stored.

An operation section 17 and a display section 18 are connected with the data bus 15 through a controller 16.

The operation section 17 includes various function keys and numeric keys. The display section 18 further displays the information indicating the dining progress of the customer P (described later in FIG. 15) as well as various kinds of information.

The data bus 15 further connects a LAN I/F (Interface) 19. The LAN I/F 19 connected with the LAN 5 receives the image captured by the camera 8 and the order from the handy terminal 7.

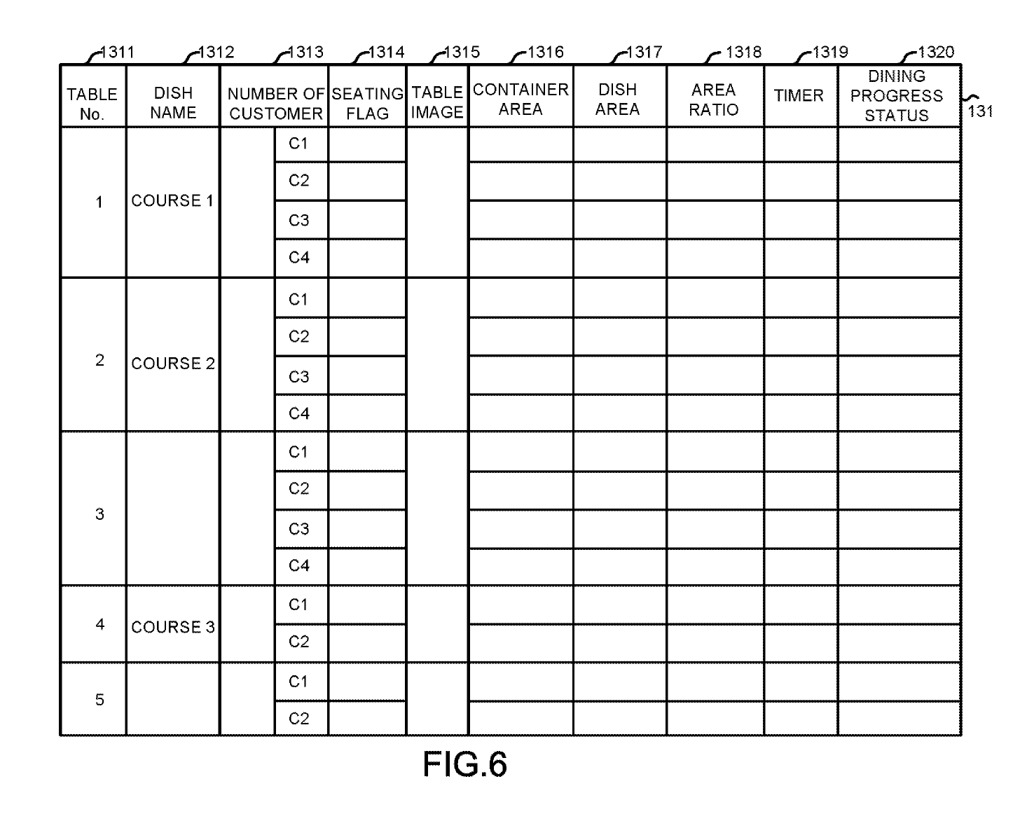

FIG. 6 is a memory map illustrating the dining progress table 131 of the RAM 13. The dining progress table 131 displays the dining progress of each customer P to determine whether or not the customer P finishes eating the served dishes. Specifically, the dining progress table 131 includes a table No. part 1311, a dish name part 1312, a number of customer part 1313, a seating flag part 1314, a table image part 1315, a container area part 1316, a dish area part 1317, an area ratio part 1318, a timer part 1319 and a dining progress status part 1320.

The table No. part 1311 stores a number attached to each table arranged in the store for specifying the tables individually. The dish name part 1312 reads the name of the dish ordered by the seated customer P from the menu storage section 142 and stores the name for each table number. The number of customer part 1313 stores the number of seated customers P for each table number.

The seating flag part 1314 stores a seating flag indicating which chair the customer P is seated in. A chair with a seating flag “1” refers to a chair in which the customer P is seated. A chair with a seating flag “0” refers to an empty chair in which no customer P is seated.

Whether or not the customer P is seated is determined by the later-described control section by determining whether or not the image of the chair C is captured based on the image captured by the camera 8. In a case in which the image of the chair C is almost not captured, it is determined that a customer P is seated in the chair C. Further, it may also be determined that a customer P is seated in the chair C if the color of hair or the hair of a human is photographed at the arrangement position of the chair C by the camera 8.

The control section determines the seating of the customer individually with respect to the arrangement position of each chair C. For example, in FIG. 4, it is determined that two customers P are seated in the two chairs C at the right side, and the seating flag of the chair where the customer is seated is set to “1”. Further, it is determined that no customer P is seated in the two chairs C at the left side, and the seating flag of the chair where no customer is seated is set to “0”.

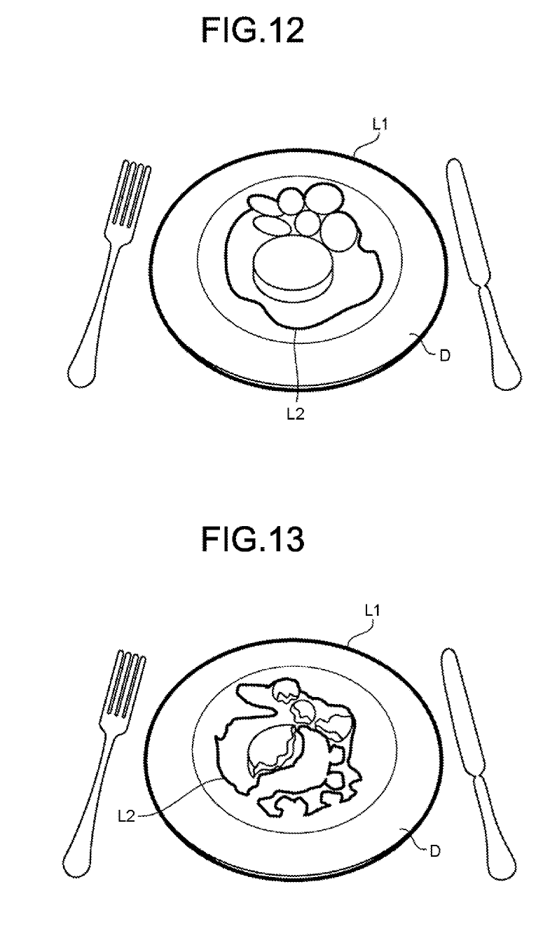

The table image part 1315 stores the images captured by the camera 8 at a unit of table. The container area part 1316 stores the area of a container D, on which the dish served to the customer P is placed, at a unit of customer seated in the chair C based on the image stored in the table image part 1315. The area of the container D is calculated by the later-described control section. As the color of the container D is in contrast to the color of the table T and the color of the tablecloth E, thus, a boundary L1 (refer to FIG. 12) serving as the outer periphery of the container D is clear, which makes it easier to calculate the area of the container D. Further, the outer periphery of the container D may be bordered to make the boundary L1 of the container D clearer. The area of the container D is calculated every time the camera 8 photographs the container D, and is stored in the container area part 1316.

The dish area part 1317 stores the area of the dish placed on the container D at a unit of customer seated in the chair C based on the image stored in the table image part 1315. The area of the dish placed on the container D is calculated by the later-described control section. As the color of the container D is in contrast to the color of the dish placed on the container D, thus, a boundary L2 (refer to FIG. 12) between the container D and the dish is clear, which makes it easier to calculate the area of the dish. Further, the area of the dish is calculated every time the camera 8 photographs the dish, and is stored in the dish area part 1317.

The area ratio part 1318 stores the area ratio of the dish to the area of the container D based on the area of the container D stored in the container area part 1316 and the area of the dish stored in the dish area part 1317 at the same timing. Compared with the state in which the dining progresses, the percentage of the dish against the container D is higher in a state in which the dish is just served, thus, the area ratio is high. Then, the area of the dish with respect to the area of the container decreases as the dining of the customer P progresses, thus, the area ratio decreases. In a case in which the customer P almost finishes eating the dish placed on the container D, the area of the dish becomes “0”, and the area ratio becomes “0” as well. The area ratio is calculated every time the camera 8 photographs the container D and the dish.

The timer part 1319 measures and stores the time period during which the area ratio does not change, that is, the customer P does not eat the dish. In a case in which the customer P continues the dining and the area ratio changes, the timer is reset. In this way, the timer part 1319 measures the time elapsing from the moment the customer P stops eating the dish.

The dining progress status part 1320 stores, in a case in which the order is a course meal, the dining progress indicating which course the customer P dines to. Specifically, for example, in a case in which the course meal includes appetizer, salad, soup, main dish and dessert, the name of the dish that is just finished is stored.

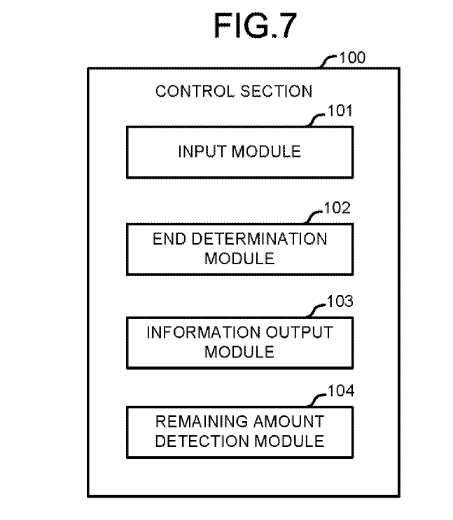

Next, the control processing of the station 1 is described with reference to FIG. 7˜FIG. 15. FIG. 7 is a functional block diagram illustrating the functional components of the station 1. The control section 100 operates according to various programs including the control program 141 stored in the memory section 14 or the ROM 12 to function as an input module 101, an end determination module 102, an information output module 103 and a remaining amount detection module 104.

The input module 101 inputs the image of a dining tool used in the dining captured by the camera 8.

The end determination module 102 determines whether or not the dining is ended according to the image of the dining tool input by the input module 101.

The information output module 103 outputs information indicating that the eating of the dish is ended if the end determination module 102 determines that the eating of the dish is ended.

The remaining amount detection module 104 detects the remaining amount of the dish left on the container according to the image of a container serving as the dining tool input by the input module 101.

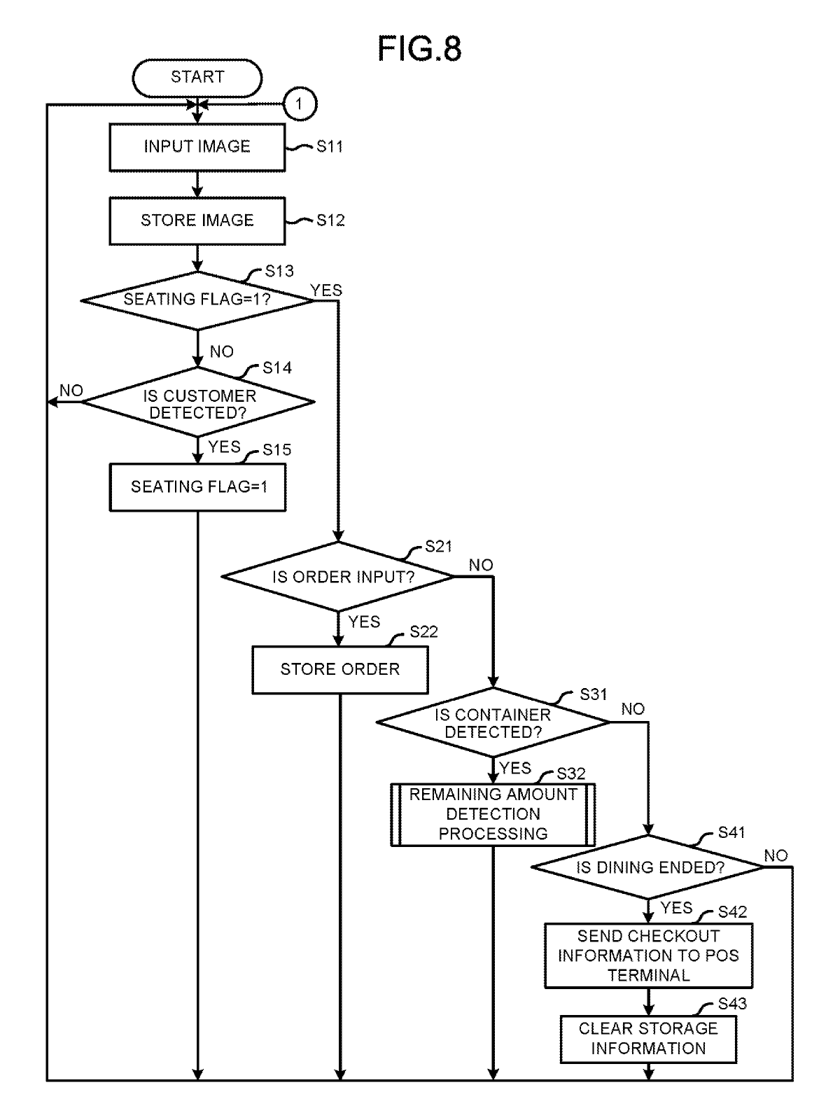

FIG. 8 is a flowchart illustrating the control processing of the station 1. If the image information is input every a pre-determined time interval from the camera 8 arranged above each table, the control section 100 independently executes the following control based on the input image information for the table No. input from the camera 8. Hereinafter, the control of the control section 100 is described for one table. The control section 100 executes the same control for other tables.

In FIG. 8, if the LAN I/F 19 receives the image captured by the camera 8 from the camera 8 through the LAN 5 every a pre-determined time, the control section 100 (input module 101) inputs the captured image received by the LAN I/F 19 from the LAN I/F 19 (ACT S11). Then the control section 100 stores the input captured image in the table image part 1315 corresponding to the photographed table No. (ACT S12). Next, the control section 100 determines whether or not a seating flag “1” is stored in any seating flag part 1314 corresponding to the table No. based on the stored captured image (ACT S13).

If it is determined that all the seating flags are “0” (NO in ACT S13), the control section 100 determines whether or not a customer seated in the chair C is detected in the way described above based on the captured image stored in ACT S12 (ACT S14). If it is determined that a customer is detected (YES in ACT S14), the control section 100 sets the seating flag corresponding to the chair C where a customer is detected to “1” (ACT S15). For example, in a case of the table No. 1 shown in FIG. 6, the seating flag corresponding to the chair C where a customer is detected within the four chairs C (chairs C1˜C4) is set to “1”. Then the control section 100 returns to ACT S11 and waits for the input of a next captured image. On the other hand, if it is determined that no customer is detected (NO in ACT S14), the control section 100 returns to ACT S11 and waits.

Further, if it is determined in ACT S13 that the seating flag “1” is stored in any seating flag part 1314 (YES in ACT S13), the control section 100 determines whether or not the order is input from the handy terminal 7 through the LAN 5 in response to the order of the seated customer P (ACT S21). If it is determined that the order is input (YES in ACT S21), the control section 100 stores the input order in a corresponding dish name part 1312 (ACT S22). Then the control section 100 returns to ACT S11 and waits.

On the other hand, if it is determined in ACT S21 that no order is input through the LAN 5 (NO in ACT S21), the control section 100 determines whether or not the container D is detected from the captured image stored in the table image part 1315 in ACT S12 (ACT S31).

The color of the container D served to the table is greatly different from the color of the table T and the color of the tablecloth E; alternatively, the outermost periphery of the container D is bordered, and the color of the border is in contrast to the color of the table T and the color of the tablecloth E. The control section 100 detects the color difference to recognize the shape of the object served to the table. Then the control section 100 compares the recognized shape with the shapes of a plurality of containers D pre-stored in the memory section 14, and if it is determined that the recognized object shape is substantially consistent with the shape of the container D stored in the memory section 14, the control section 100 recognizes the object as the container D having the substantially consistent shape. Such a recognition method is the well-known outline recognition. The recognition of the container D through the outline recognition technology is just described as an example, and the container D may be recognized through other method than the outline recognition technology. In a case in which the container D is recognized, the control section 100 determines that the container D is detected.

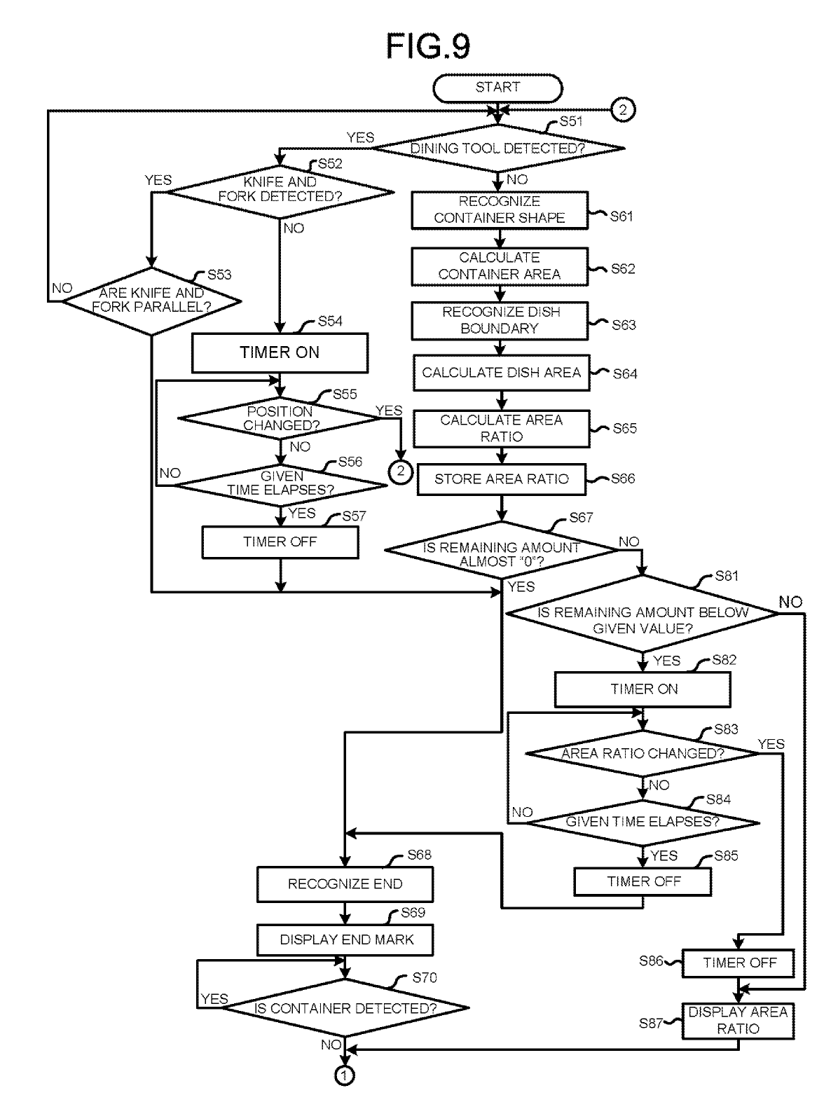

If it is determined that the container D is detected through the outline recognition technology described above (YES in ACT S31), the control section 100 executes the remaining amount detection processing described later in FIG. 9 (ACT S32). Then the control section 100 returns to ACT S11 and waits.

On the other hand, if it is determined that the container D is not detected (NO in ACT S31), the control section 100 determines whether or not the customer P eats all the dishes and the dining is ended (ACT S41). Whether or not the dining is ended is determined according to the type of the order stored in the dish name part 1312 and the status stored in the dining progress status part 1320, and if it is stored in the dining progress status part 1320 that all the customers P seated around the same table finish the last dish within the ordered dishes, the control section 100 determines that the dining is ended in ACT S41.

If it is determined that the dining is ended (YES in ACT S41), the control section 100 sends the checkout information to the POS terminal 2 (ACT S42). The control section 100 clears all the storage information of the table No. stored in the dining progress table 131 (ACT S43). Then the control section 100 returns to ACT S11 and waits.

Next, the remaining amount detection processing in ACT S32 executed by the control section 100 is described in detail with reference to FIG. 9. In FIG. 9, first, the control section 100 (dining tool detection module 105) determines whether or not it is detected that the dining tools used in hand during the dining such as knife, fork, spoon and chopsticks are in the container D through the outline recognition technology described (ACT S51). If it is determined that the dining tools are detected in the container D (YES in ACT S51), the control section 100 determines whether or not the detected dining tool is knife and fork (ACT S52). If it is determined that the detected dining tools are knife and fork (YES in ACT S52), the control section 100 determines whether or not the detected knife and fork are placed in the container D in a manner of being parallel to each other (ACT S53).

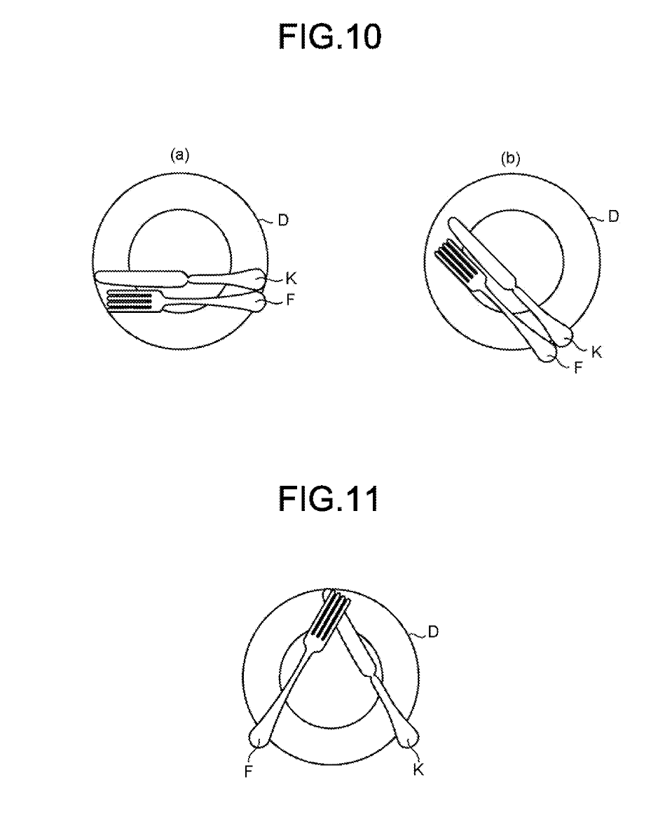

The state in which the knife and fork are placed in the container D in a manner of being parallel to each other is shown in FIG. 10 (a) and FIG. 10 (b). FIG. 10 (a) shows a state in which a knife K and a fork F are placed in the container D in a manner of being parallel to each other in the left-right direction. FIG. 10 (b) shows a state in which a knife K and a fork F are placed in the container D in a manner of being parallel to each other in an inclined direction. In FIG. 10 (b), parts of the knife K and the fork F protrude from the container D. As stated above, in a case in which the knife K and the fork F are placed side by side in a manner of being contacted with each other or in a manner of being close to each other, the control section 100 determines in ACT S53 that the knife K and the fork F are placed parallel to each other.

FIG. 11 shows a state in which the knife K and the fork F are placed on the container D in a “ [symbol] ” shape. In this state, the control section 100 determines in ACT S53 that the knife K and the fork F are not placed in a manner of being parallel to each other. In addition, FIG. 11 is just an example of the state in which the knife K and the fork F are not placed in a manner of being parallel to each other; the control section 100 determines that the knife K and the fork F are not placed in a manner of being parallel to each other, unless the knife K and the fork F are placed side by side in a manner of being contacted with each other or in a manner of being close to each other.

Return to the description in FIG. 9. If it is determined that the knife K and the fork F are placed parallel to each other (YES in ACT S53), the control section 100 (end determination module 102) recognizes that the customer P finishes the dish placed in the container D (ACT S68). In this case, the control section 100 displays a triangle mark 43 (refer to FIG. 15) indicating that the dining is ended on the monitor 3 and the display section 18 of the station 1 (ACT S69)

An example of the display of the monitor 3 is shown in FIG. 15. In FIG. 15, the monitor 3 displays a table No. part 31, a dish name part 32, a number of customer part 33, and dish progress parts 34˜42. The table No. part 31 displays a number attached to each table arranged in the restaurant for specifying the tables individually. The dish name part 32 displays the name of the dish ordered by the seated customer P for each table number. The number of customer part 33 displays the number of seated customers P for each table number. The dish progress parts 3442 display the dish contained in the order displayed in the dish name part 32 for each dish. In the example shown in FIG. 15, the dishes such as appetizer 34, salad 35, soup 36, fish dish 37, sorbet 38, meat dish 39, cheese 40, dessert 41 and coffee 42 are displayed as the types of the dishes contained in the progress parts 3442. Further, the types and the serving order of the dishes are not limited to the example shown in FIG. 15.

In the example shown in FIG. 15, as to the table No.1, four customers P are seated around the table and the course meal of course 1 is ordered. As to the table No.2, three customers P are seated around the table and the course meal of course 2 is ordered. The table No.3 is an empty table. As to the table No.4, two customers P are seated around the table and the course meal of course 3 is ordered. The table No.5 is an empty table.

In FIG. 15, the triangle mark 43 directed towards the right side indicates that the eating of the corresponding dish is ended. All the customers P seated around the table No.1 finish eating the appetizer 34˜sorbet 38. It is displayed that the customer P seated in the chair C2 finishes eating the meat dish 39. It is displayed that all the customers P seated around the table No.2 finish eating the appetizer 34˜soup 36.

Return to the description in FIG. 9. Next, the control section 100 still determines whether or not the container D is detected (ACT S70). If it is determined that the container D is detected (YES in ACT S70), the control section 100 waits. If it is determined that the container D is not detected (NO in ACT S70), the control section 100 returns to ACT S11 shown in FIG. 8 and waits. Further, if it is determined in ACT S53 that the knife K and the fork F are not placed in a manner of being parallel to each other (NO in ACT S53), the control section 100 returns to ACT S51 and waits.

On the other hand, if it is determined in ACT S52 that the knife K and the fork F are not detected (NO in ACT S52), the control section 100 turns on the timer (ACT S54). The timer updates at a unit of one second, and stores the updated timer information in the corresponding timer part 1319 each time. Then the control section 100 determines whether or not the position of the detected dining tool other than the knife K and the fork F is changed compared with the position of the dining tool photographed by the camera 8 last time (ACT S55).

If it is determined that the position is not changed (NO in ACT S55), it is determined whether or not the time period during which the position of the dining tool is not changed is longer than a pre-determined time (for example, ten minutes) (ACT S56). If it is determined that the time period is not longer than the pre-determined time (NO in ACT S56), the control section 100 returns to ACT S55 and waits. On the other hand, if it is determined that the time period is longer than the pre-determined time (YES in ACT S56), the control section 100 turns off the timer (ACT S57). This means that the pre-determined time elapsed since the last time the customer P touched the dining tool, and the control section 100 determines that the eating of the dish is ended, and then executes the processing in ACT S68.

If it is determined in ACT S55 that the position of the dining tool is changed (YES in ACT S55), the control section 100 determines that the customer is still dining, and then returns to ACT S51 and waits.

On the other hand, if it is determined in ACT S51 that the dining tool is not detected in the container D (NO in ACT S51), the control section 100 determines whether or not the dining is ended according to the state of the dish in the container D. Specifically, the control section 100 first recognizes the shape of the container D through the outline recognition technology described above (ACT S61). Next, the control section 100 calculates the area of the container D according to the shape of the recognized container D (ACT S62). Then the control section 100 stores the calculated area of the container D in a corresponding container area part 1316. At this time, the control section 100 does not delete the area stored in the container area part 1316 until now.

Then the control section 100 recognizes the boundary L2 of the dish in the container D (ACT S63). Herein, the recognition of the boundary L2 of the dish in the container D is described with reference to FIG. 12˜FIG. 14. In FIG. 12˜FIG. 14, the dish is placed on the container D and served, and since the color of the dish is greatly different from the color of the container D, thus, the control section 100 recognizes the boundary between the two contrast colors as the boundary L2 between the container D and the dish based on the image captured by the camera 8.

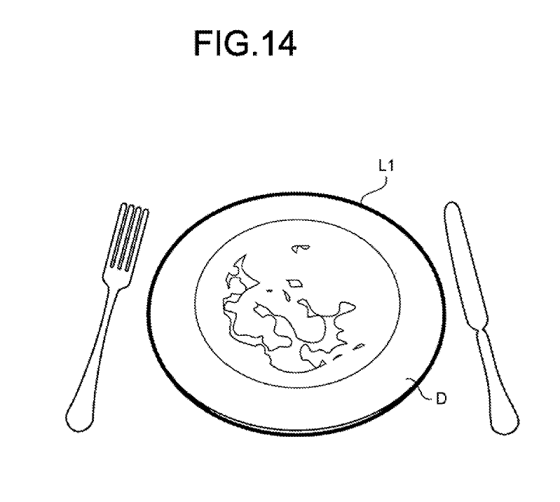

FIG. 12 is a diagram illustrating the dish placed in the container D in a state in which the dish is just served and the customer P does not start to eat yet, and in FIG. 12, the dish is placed on the container D at a pre-determined ratio to the container D. FIG. 13 is a diagram illustrating a state in which the dining progresses from the state shown in FIG. 12 and the amount of the dish is reduced. Compared with the state shown in FIG. 12, the ratio of the dish to the container D is reduced. FIG. 14 is a diagram illustrating a state in which the dining is further continued and almost no dish remains in the container D (dining ending state).

Return to the description in FIG. 9. The control section 100 calculates the area of the dish based on the recognized boundary L2 (ACT S64). The control section 100 stores the calculated area of the dish in a corresponding dish area part 1317. The control section 100 calculates the area every time the camera 8 photographs the table, and stores the area in the dish area part 1317 newly. At this time, the control section 100 does not delete the area stored in the dish area part 1317 until now.

Next, the control section 100 (remaining amount detection module 104) calculates the area ratio serving as the ratio of the area of the dish to the area of the container D based on the area of the container D stored in the container area part 1316 and the area of the dish stored in the dish area part 1317 (ACT S65). The control section 100 stores the calculated area ratio in the area ratio part 1318 (ACT S66). At this time, the control section 100 does not delete the area ratio stored in the area ratio part 1318 until now.

Next, the control section 100 determines whether or not the remaining amount of the dish is almost “0” (for example, below 5%) based on the area ratio stored in the area ratio part 1318 (ACT S67). In a case in which the latest area ratio stored in the area ratio part 1318 is almost “0”, it means the state shown in FIG. 14 in which almost no dish remains in the container D.

If it is determined that the remaining amount of the dish is almost “0” (YES in ACT S67), the control section 100 determines that the dining is ended, and executes the processing in ACT S68. If it is determined that the remaining amount of the dish is not almost “0” (NO in ACT S67), the control section 100 determines whether or not the remaining amount of the dish placed in the container D is smaller than a pre-determined amount (for example, the state shown in FIG. 13) (ACT S81). Since some customers do not eat up all the dishes, thus, it is determined that the dining is ended if the state in which the remaining amount of the dish is smaller than the pre-determined amount lasts for a pre-determined time.

If it is determined that the remaining amount of the dish placed in the container D is smaller than the pre-determined amount (YES in ACT S81), the control section 100 turns on the timer (ACT S82). Then the control section 100 compares the area ratio stored in the area ratio part 1318 last time with the area ratio stored this time to determine whether or not the area ratio is changed (ACT S83). If the area ratio is changed, it means that the dining is still continued.

If it is determined that the area ratio is not changed (NO in ACT S83), the control section 100 determines whether or not the state in which the area ratio is not changed lasts for a pre-determined time (for example, 10 minutes) (ACT S84). If it is determined that the state does not last for the pre-determined time (NO in ACT S84), the control section 100 returns to ACT S83 and waits. If it is determined that the state lasts for the pre-determined time (YES in ACT S84), the control section 100 turns off the timer (ACT S85). Then the control section 100 determines that the eating of the dish is finished, and then executes the processing in ACT S68.

On the other hand, if it is determined in ACT S83 that the area ratio is changed (YES in ACT S83), the control section 100 determines that the dining is still continued, turns off the timer (ACT S86), and then displays the change rate (the degree to which the dining progresses) between the latest area ratio stored in the area ratio part 1318 and the area ratio stored initially on the monitor 3 and the display section 18 of the station 1 (ACT S87). Then the control section 100 returns to ACT S11 shown in FIG. 8 and waits. If it is determined in ACT S81 that the remaining amount of the dish placed in the container D is not smaller than the pre-determined amount (NO in ACT S81), the control section 100 executes the processing in ACT S87.

In FIG. 15, a numeric 44 displayed in the dish progress parts 34˜42 indicates the change rate between the latest area ratio stored in the area ratio part 1318 and the area ratio stored initially. For example, the numeric 44 “50” indicates that the latest area ratio stored in the area ratio part 1318 is 50% of the area ratio stored initially; that is, the customer P ate almost half of the dish. Further, a numeric “100” indicates that the latest area ratio stored in the area ratio part 1318 is the same as the area ratio stored initially; that is, the customer P does not start to eat the dish yet.

The display mark 45 “-” displayed in the dish progress parts 34˜42 indicates that the dish is not contained in the course. In the example shown in FIG. 15, the meat dish 39 and the cheese 40 are not contained in the course 2. The fish dish 37 and the dessert 41 are not contained in the course 3.

In such an embodiment, the dining progress of the customer P can be correctly known from the progress and the ending status of each dish according to the remaining amount of the dish, thus, it is possible to serve the next dish to the customer P at a proper timing.

In the embodiment, the dining progress of the customer P can be correctly known from the progress and the ending status of each dish according to the remaining amount of the dish based on the area ratio between the container D and the dish, thus, it is possible to serve the next dish to the customer P at a proper timing.

Further, in the embodiment, the dining progress of the customer P can be correctly known based on the state of the dining tools used in hand during the dining, thus, it is possible to serve the next dish to the customer P at a proper timing.

While certain embodiments have been described, these embodiments have been presented by way of example only, and are not intended to limit the scope of the present invention. Indeed, the novel embodiments may be embodied in a variety of other forms; furthermore, various omissions, substitutions, variations and combinations thereof may be devised without departing from the spirit of the present invention. The accompanying claims and their equivalents are intended to cover such forms and modifications as would fall within the scope and spirit of the present invention.

For example, it is detected that the knife K and the fork F are parallel to each other in the embodiment; however, it is also applicable to detect that any two types or more than two types of dining tools within the knife K, the fork F and the spoon are parallel to one another.

In the embodiment, the ending of dining is determined based on the state of the dining tools as well as the dining progress of the dish; however, the determination of the ending of dining based on the state of the dining tools is not required.

The knife K, fork F, spoon, chopsticks and the like are exemplified as the dining tools in the embodiment; however, the dining tools may be any other tools that are used in hand during the dining.

The dining progress is determined according to the change rate of the area ratio in the embodiment; however, the dining progress may be determined according to the area ratio directly.

The remaining amount detection of the course meal of which the dish order is determined is exemplified in the embodiment; however, it is not limited to this. It may also be applied in a case in which a plurality of dishes of which the dish order is not determined is ordered.

The programs executed in the station 1 of the present embodiment are recorded in a computer-readable recording medium such as CD-ROM, flexible disk (FD), CD-R, DVD (Digital Versatile Disk) and the like in the form of installable or executable file.

Further, the program executed in the station 1 of the present embodiment may be stored in a computer connected with a network such as internet, and downloaded via the network. Further, the program executed in the station 1 of the present embodiment may also be provided or distributed via a network such as the Internet.

The program executed in the station 1 of the present embodiment may also be installed in the ROM 12 in advance.

What is claimed is:

1. A dish remaining amount detection apparatus comprising:
an input module configured to input an image of a dining tool used during dining captured by a camera;
an end determination module configured to determine whether or not the dining is ended according to the image of the dining tool input by the input module; and
an information output module configured to output information indicating that the eating of a dish is ended if the end determination module determines that the eating of the dish is ended.

2. The dish remaining amount detection apparatus according to claim 1, wherein
the input module inputs the image of a container serving as a dining tool in which the dish is placed;
further comprising:
a remaining amount detection module configured to detect the remaining amount of the dish remaining in the container from the image of the container input by the input module; wherein
the end determination module determines whether or not the dining is ended according to the remaining amount of the dish detected by the remaining amount detection module.

3. The dish remaining amount detection apparatus according to claim 2, wherein
the remaining amount detection module detects the remaining amount of the dish according to an area ratio between the area of the container and the area of the dish placed in the container; and
the end determination module determines whether or not the eating of the dish is ended in a case in which the area ratio is smaller than a pre-determined value.

4. The dish remaining amount detection apparatus according to claim 1, wherein
the input module inputs the image of the dining tool used in hand during the dining as the dining tool; and
the end determination module determines that the eating of the dish is ended in a case in which the dining tool used in hand during the dining is in a pre-determined state in the input image.

5. The dish remaining amount detection apparatus according to claim 4, wherein
the end determination module determines that the eating of the dish is ended in a case (that is, the pre-determined state) in which two or more than two types of dining tools used in hand during the dining are placed parallel to one another in the image input by the input module.

6. A dish remaining amount detection method, including:
inputting an image of a dining tool used during dining captured by a camera;
determining whether or not the dining is ended according to the image of the dining tool input by the input module; and
outputting information indicating that the eating of a dish is ended if the end determination module determines that the eating of the dish is ended.
